(19) United States
(12) Patent Application Publication
(10) Pub. No.: US 2005/0234766 A1
(43) Pub. Date: Oct. 20, 2005

(54) Method of improving administrative functions of a business using valve streams

(76) Inventor: Thomas J. Shuker, Grand Rapids, MI (US)

Correspondence Address: Miller, Canfield, Paddock and Stone, P.L.C.;c/o Robert Kelley Roth, Suite 2500, 150 West Jefferson Ave, Detroit, MI, 48226, US

(21) Appl. No.: 11/105,952

(22) Filed: Apr. 14, 2005

Related U.S. Application Data
(60) Provisional application No. 60/562,064, filed on Apr. 14, 2004.

(51) Int. Cl. G06F 17/60

(52) U.S. Cl. 705/10; 705/1

(57) ABSTRACT

A method for improving an administrative function of a business is disclosed comprising the steps of selecting an administrative value stream having a series of steps, preparing a current state value stream map corresponding to the administrative value stream, preparing a future state value stream map based on lean concepts to create a future administrative value stream, and implementing the future state value stream.

### RELATED APPLICATION

This application claims priority benefit of U.S. provisional patent application No. 60/562,064 filed on Apr. 15, 2004.

### FIELD OF THE INVENTION

This invention relates to improvements in methods for tracking and controlling administrative functions in a business, and more particularly to using an enterprise value stream method for mapping and improving such administrative functions.

### BACKGROUND OF THE INVENTION

Each business has a series of steps or functions it uses to make a product or provide a service. Traditionally these business steps range from initial customer order to final customer delivery and have been organized based on function (engineering, sales, shipping and receiving, accounting, etc.). An value stream can be thought of as all of the steps required to enable a business to provide its customer with the desired goods or services. A value stream map is a tool to display the flow of material and information as they move through the value stream. Value stream maps can reflect the current state of business steps and can also reflect a future state of business steps. Value stream concepts have been used by manufacturing companies to help map their manufacturing processes. As it has typically been thought that services were relatively immune to improvements through value stream concepts, since significant elements administrative processes were thought not to be visual (i.e., not easily mapped and monitored), and because of the lack of standardization in administrative processes. The only administrative processes addressed using value stream concepts has been scheduling of materials in a manufacturing process, which is closely related to manufacturing processes.

U.S. Patent Publication 2004/0039625 to Malnack et al discloses a value stream process management approach and website, but does not disclose the use of current state value stream mapping, or any techniques for improving a current state map once it is created. It would be desirable to develop and implement improved administrative functions of a business that reduce costs and time associated with making a product or providing a service.

### SUMMARY OF THE INVENTION

In accordance with a first aspect, a method for improving an administrative function of a business comprises the steps of selecting an administrative value stream, preparing a current state value stream map corresponding to the administrative value stream, preparing a future state value stream map based on lean concepts to create a future administrative value stream, and implementing the future state value stream.

From the foregoing disclosure and the following more detailed description of various preferred embodiments it will be apparent to those skilled in the art that the present invention provides a significant advance in the technology for defining, controlling and improving administrative functions in a business. Particularly significant in this regard is the potential the invention affords for providing an improved method of reducing costs and time associated with administrative functions in a business. Additional features and advantages of various preferred embodiments will be better understood in view of the detailed description provided below.

### BRIEF DESCRIPTION OF THE DRAWINGS

FIG. 1 is a flow chart that outlines the process for improving administrative functions of a business using the value stream process in accordance with a preferred embodiment.

FIG. 2 is a flow chart showing representative administrative value streams in a business.

FIG. 3 is a table showing the lean concepts or techniques that are used to create a future state value stream map.

FIGS. 4A-4B are an example of a current state value stream map for a pricing process entitled Product Cost Development Material Budget in accordance with a preferred embodiment.

FIGS. 5A-5B are an example of a future state value stream map created from the current state value stream map of FIG. 4 using lean concepts.

FIG. 6 is an example of a current state value stream map for a coordination of benefits process in accordance with another preferred embodiment.

FIG. 7 is an example of a future state value stream map created from the current state value stream map of FIG. 6 using lean concepts.

FIG. 8 is an example of a current state value stream map for a patient clinic visiting process in accordance with another preferred embodiment.

FIG. 9 is an example of a future state value stream map created from the current state value stream map of FIG. 8 using lean concepts.

FIG. 10 is a before and after table comparing the current administrative value stream of FIG. 8 with the future administrative value stream of claim 8.

FIG. 11 shows a current state office furniture layout.

FIG. 12 shows a future state office furniture layout implemented based on a future state value stream map generated using lean concepts.

It should be understood that the appended drawings are not necessarily to scale, presenting a somewhat simplified representation of various preferred features illustrative of the basic principles of the invention. The specific features of the method disclosed here will be determined in part by the particular intended application and use environment. Certain features of the illustrated embodiments have been enlarged or distorted relative to others to enhance visualization and clear understanding. In particular, thin features may be thickened, for example, for clarity of illustration. All references to direction and position, unless otherwise indicated, refer to the orientation illustrated in the drawings.

### DETAILED DESCRIPTION OF CERTAIN PREFERRED EMBODIMENTS

It will be apparent to those skilled in the art, that is, to those who have knowledge or experience in this area of technology that many uses and design variations are possible for the method disclosed here. The following detailed discussion of various alternative and preferred features and embodiments will illustrate the general principles of the invention with reference to improved administrative functions of a business. Other embodiments suitable for other applications will be apparent to those skilled in the art given the benefit of this disclosure.

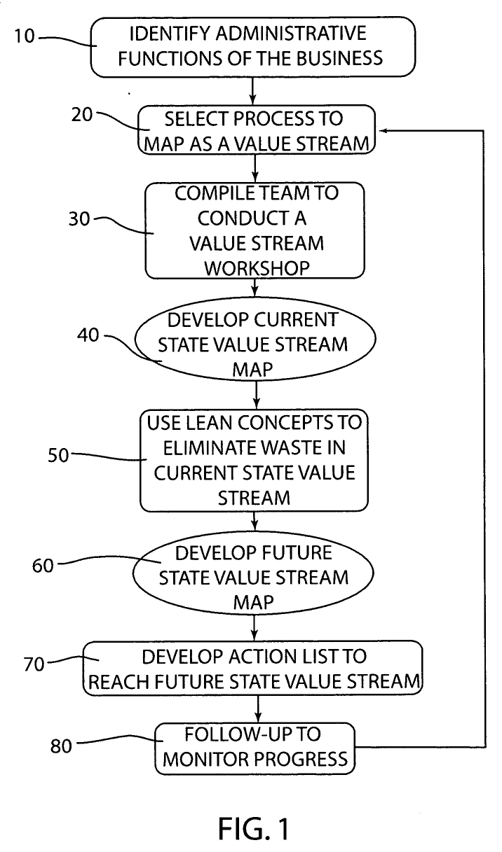

Referring now to the drawings, FIG. 1 is a flow chart which provides a broad overview of the value stream process 10, also known as the office lean process. Broadly speaking, there are eight steps as follows.

10 Preparation phase. Identify the administrative business functions or group of functions of a company. Generally, business functions can be treated as one of several groups of value streams: concept-to-launch value streams and order-to-cash value streams are administrative value streams, and raw material-to-finished goods is a manufacturing value stream. Administrative value streams typically have one or more inputs from other value streams, and one or more outputs to other value streams. Inputs are the product or service of the initial or previous step in the process and can include, for example, a request for a quotation, a request for a purchase order, or an account payable. Outputs are the deliverable(s) to the next step or the ultimate end customer of the value stream and can include, for example, preparation of a quote, preparation of a purchase order, or payment on an account payable. Generally, administrative value streams receive inputs from upstream administrative value streams or suppliers and send outputs to downstream administrative value streams or customers. The terms suppliers and customers are used here only to refer to their location in the process flow relative to a selected administrative value stream. Thus, a given administrative value stream may be a customer in one instance and a supplier in another, depending on the selected administrative value stream.

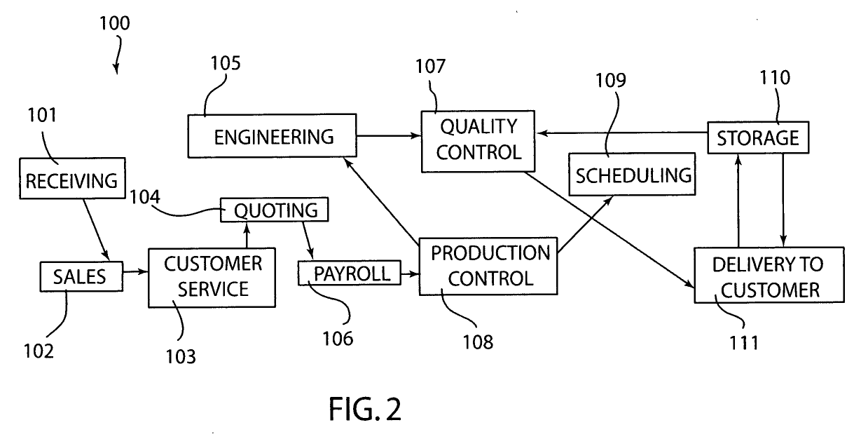

FIG. 2 shows a flow chart 100 of representative departments of a conventional business, organized by function, including receiving 101, sales 102, customer service 103, quoting 104, engineering 105, payroll 106, quality control 107, production control 108, scheduling 109, storage/warehouse/inventory 110, and delivery to customer 111. As noted above, value streams are defined as all the steps required to complete a business process, starting with customer order and ending with customer delivery of a good or service. Administrative value streams would include non-manufacturing related value streams and service value streams, such as health care values streams. Some anticipatory and monitoring elements of an administrative value stream may occur prior to order entry and after customer delivery

Examples of concept-to-launch values streams comprise, for example, a drafting release process, a product development process, a pricing process (for goods, services, or both), a procurement of raw materials or services process, an engineering proposal process, a process for customer ordering and/or preparation of quotes for the customer, and a quality control plan release process. These value streams support a product or service that is ordered by the end customer. Examples of order-to-cash value streams comprise, for example, an order lead time process, a customer return process, a contested invoice process, a month end closing process, a new hire application process, a drafting revision process for updating documents, including CAD drawings, a product enhancement process, a clinic visit process, a clinic discharge process, and a coordination of fringe benefits process. Other administrative value streams will be readily apparent to those skilled in the art given the benefit of this disclosure.

20 Select an administrative function or process for mapping as a value stream. This step involves prioritization of actions to be taken to improve administrative business functions.

30 Compile a group of workers which forms a team to conduct a value stream workshop. Preferably the members of the workshop include workers experienced with the details of the selected administrative value stream. Further, the members of the workshop should include workers experienced with the details of administrative value streams which occur immediately before the targeted administrative value stream (“upstream,” or “suppliers”), and should include workers experienced with the details of administrative value streams which occur immediately after the targeted administrative value stream (“downstream,” or “customers”).

40 Draw a Current State Value Stream Map of the selected Administrative Value Stream. In accordance with a highly advantageous feature, each Current State Value Stream Map has at least the following five elements:
1. A list of all of the steps required to complete the administrative value stream.

2. A lead time for each step. The lead time is the amount of time it takes to complete each step, and is also the amount of time between steps. A total lead time is the sum of all of the lead times.

3. A process time for each step. Process time is the amount of time a worker spends actually working on a process step. This can be as much as the lead time, but not more than the lead time. A total process time is the sum of all of the process times.

4. A percentage correct and/or accurate of a given administrative value stream. A step has an input (which can include material worked on at a given step), and not necessarily all inputs are accurate. This metric determines the percent correct and accurate of the input data at that step. The Current State Value Stream Map records the rate of accuracy both at given steps and as a total percent correct. The total percent correct is the multiplier of the percent corrects at any given step in the map.

5. An information flow between steps. Information flow can comprise inputs required, including multiple inputs and inputs required from more than one other value stream) and outputs, including multiple outputs and outputs to more than one other value stream. The information flow is preferably represented on the Current State Value Stream Map as lines or arrows connecting steps.

In addition, each Current State Value Stream Map may further comprise one or more of the following:

1. A value added time for each step. This is the productive time spent actually adding value to the work done at a step. It is usually significantly less than the lead time working on a step. Optimally value added time would be equal to the process time.

2. A number of workers required for each step.

3. A number of times rework is done or revisions are required.

4. An identification of the kind of information technology used. This can be helpful in identify incompatible or semi-compatible software and hardware systems.

5. A batch size. Examples of batch size include for example, one whole days worth of purchase orders to be processed, or one whole week of accounts payable. Generally, when using lean concepts, it is desirable to reduce batch size.

6. A range of lead times for each step of an administrative value stream, an average for the lead time of all of the steps, and a standard deviation for all of the lead times for the given administrative value stream.

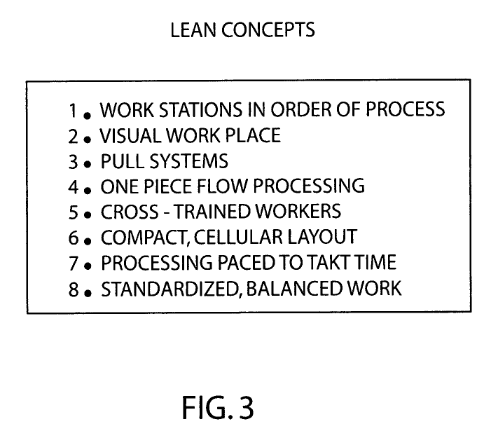

50 Use lean concepts to identify waste and inefficiency in the current state. In accordance with a highly advantageous feature, the current state value stream map is analyzed using at least one (and most preferably all) of several lean concepts. These comprise, for example, the list on FIG. 3, discussed in detail below.

1. Organizing work stations (a place where a worker works) in the order of each step of an administrative value stream (i.e., by work flow), in contrast to traditional organization of work stations by function.

2. Presenting a visual status of the administrative value stream to workers working on that value stream. This may take the form of posters mounted on a wall indicating work flow, or an electronic presentation. Provisions may be made for updating the visual status as steps of the administrative value stream are completed, and for providing data for monitoring the administrative value stream.

3. Balancing workflow between steps of the administrative value stream. Each step has a lead time. Generally, it is preferably to have the lead times be as short as possible. It is advantageous that the lead times between steps be similar, as workers work at each step can be made more even and more equitable. Thus, a standard deviation of lead times for a given administrative value stream should be as small as possible.

4. Reducing Batch size. Large batch sizes can overwhelm a process, making it difficult to balance steps and reduce overall process time.

5. Cross-training workers. Advantageously cooperating with the lean concept of balancing workflow is cross-training of workers. The amount of work to be done at each step is (if balanced) roughly the same, and so, it is easier for cross-trained workers to fill in for one another. Also, cross-training is advantageous for boosting morale by providing a better understanding of the work or others in the organization and by providing new intellectual stimulation at work.

6. Placing workers together who work together on the administrative value stream, instead of organizing workers by function. This advantageously reduces the amount of time spent traveling between workers, reducing overall process time.

7. Setting a pace of the administrative value stream based on available time divided by customer demand. Takt time is defined as available time for a process divided by customer demand so that product flows at a rate determined by the customer. Takt time is a useful measurable for establishing the rate or pace the administrative value stream needs to produce to meet customer demand.

8. Standardizing work done by different workers working on the same administrative value stream. This involves agreeing on a set of procedures for performance of work as it is done by different workers working on the same administrative value stream.

60 Draw a Future State Map that reduces lead time for each step, the overall lead time for all of the steps, the standard deviation of the lead time for all of the steps of a given administrative value stream, the process time for each step, and rework inside the process, using the lean concepts discussed above. Functional departments that exist in a typical organization would continue to exist on paper, but would then be physically rearranged to follow the flow of the value stream.

70 Develop an action list describing what will happen and when it will happen to implement the future state administrative value stream. In accordance with a highly advantageous feature, the future state administrative value stream should be checked for potentially patentable subject matter.

80 Monitoring the implementation of the future state administrative value stream. If necessary, the process may be repeated.

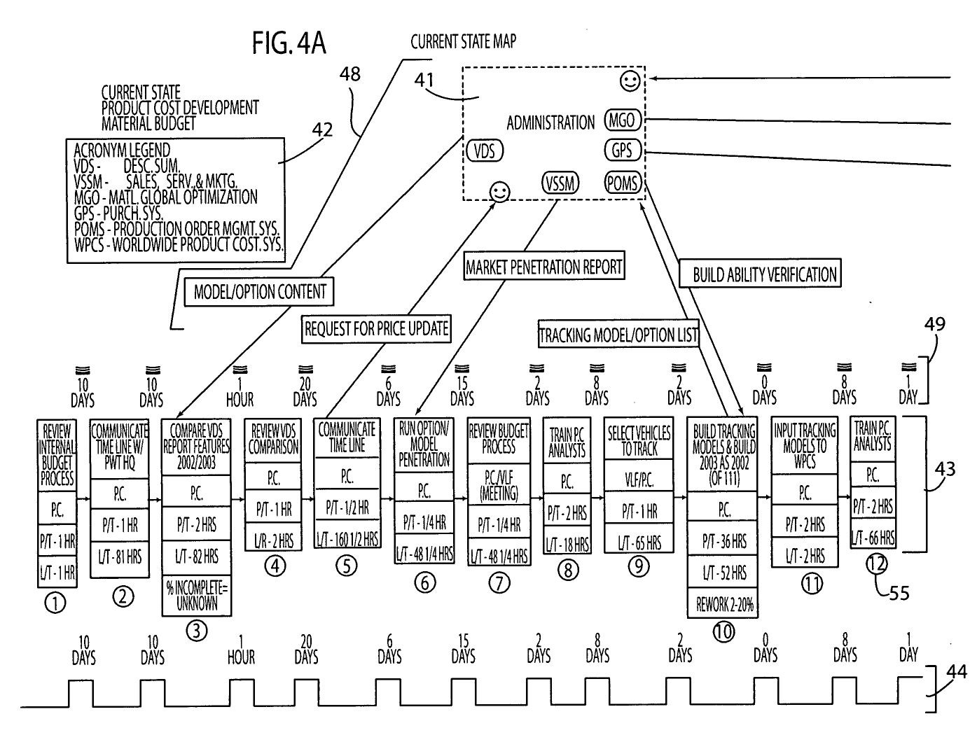

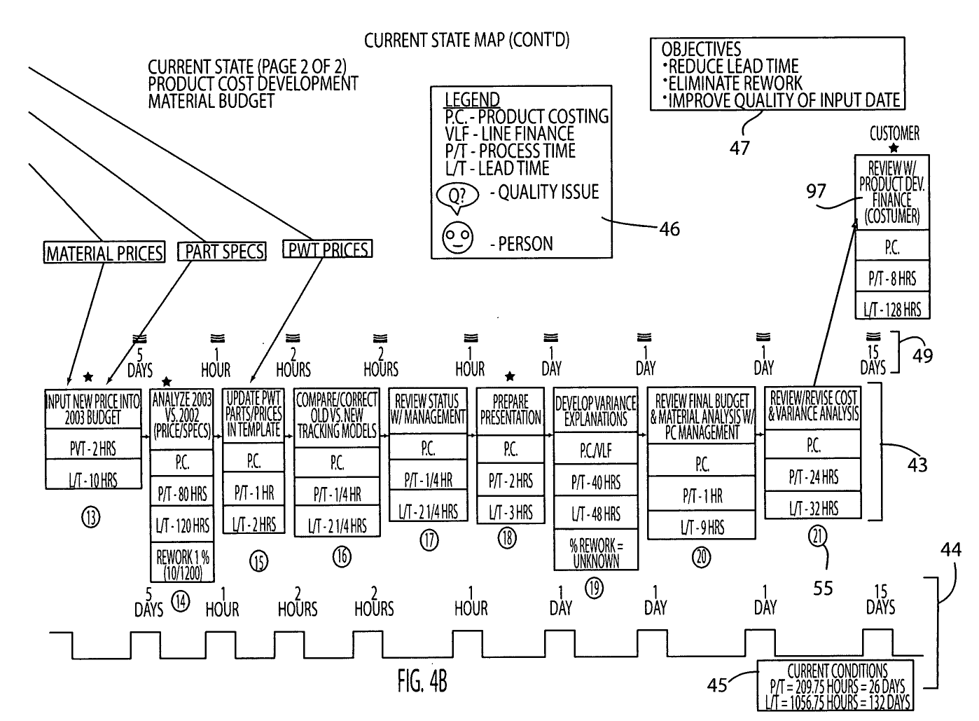

FIGS. 4A-12 disclose various examples of administrative processes improved using value stream maps. FIGS. 4A-4B provide an example of a current state administrative value stream map. In this case, the administrative function is a concept-to-launch value stream, a pricing process called “Product Cost Development”. A team was created and a workshop convened. Principle goals of the value stream mapping workshop was to reduce cost and lead-time. Generally, other goals of a value stream mapping workshop comprise increasing quality, reducing information flow and increasing percent correct and accurate at each step. The current state map in FIGS. 4A-4B has been developed with the assistance of those experienced with the given administrative value stream, including those who perform the processes each day. The current state value stream map includes both material and information flow. The current state map allows team members to see and agree on how the process currently operates in order to bring a product or service to completion.

In this exemplar map, there are twenty-one steps 55, shown in a row of process and data boxes 43. Process and data boxes identify the step, show lead times and process times, and where applicable (as in steps 3, 10, 14 and 19) a percentage correct or accurate. The lead times are shown twice, once in row 49 above the row 43 and once below row 43 in row 44 in a slightly different format. To 8 help simplify the map and increase the amount of information that can be placed on the map, acronyms are used. An acronym legend 42 is provided on FIGS. 4A and another legend 46 is provided on FIG. 4B. For example, a stylized Q is provided to indicate places where the data may be somewhat subjective or difficult to quantify. FIG. 4A shows an administration box 41 with various acronyms referring to elements of administration. The smiley face is representative of a person. Information flows 48 are shown and labeled, and where the information flows to a person, a smiley face is used. FIG. 4B completes the current state value stream map, and has a list of objectives 47, an end customer or customers 97 which receives outputs, and a summary box 45 which lists total lead time and total process time.

The team used lean concepts to identify waste within the administrative value stream. The following types of waste were reviewed:
Overprocessing—performing more work than is needed
Overproduction—performing the work faster than is needed
Correction—reviewing for or making errors
Waiting—waiting for responses or information to complete the task
Motion—excess movement to complete the task
Inventory—excess work that needs to be completed
Material Movement—moving material to the next process.

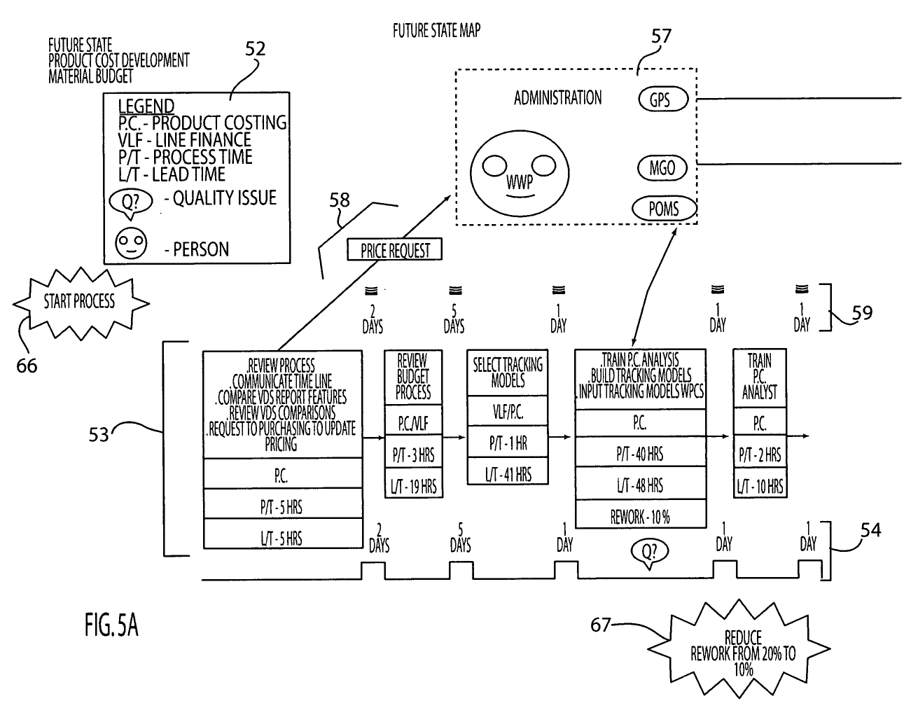

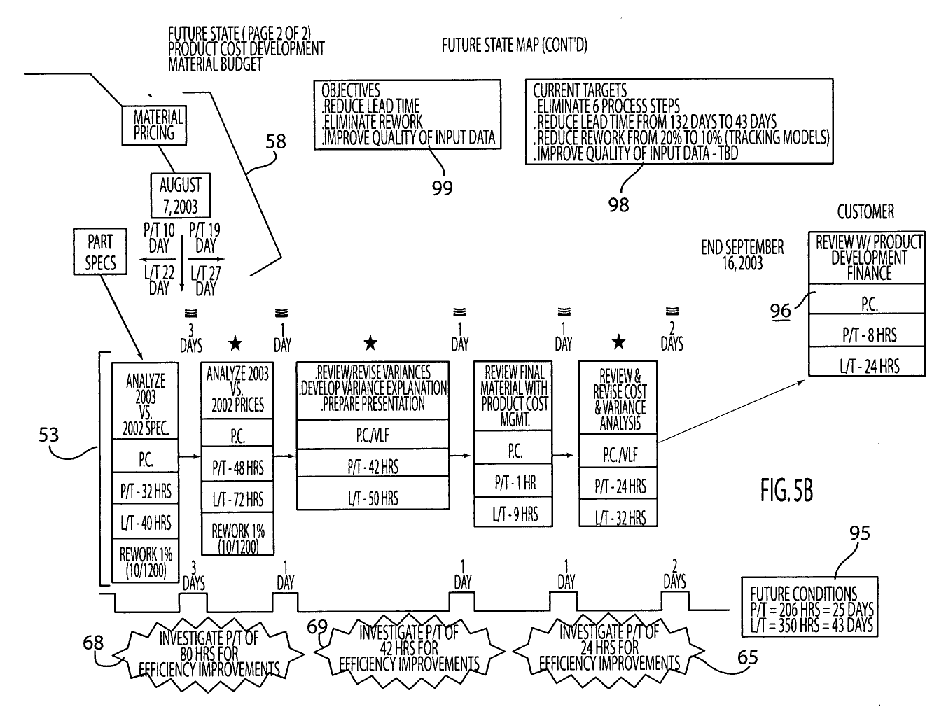

The team then worked to develop a future state administrative value stream map. This is a map of how the team thinks the process will operate, with as little of the waste identified as possible. FIGS. 5A-5B shows an example of a future state administrative value stream map for the pricing process called “Product Cost Development” based upon the corresponding current state administrative value stream map shown in FIGS. 4A-4B. Using lean concepts, the number of steps has been reduced from 21 to 11, the total lead time has been reduced from 132 days to 43 days, and the total process time has been reduced from 26 days to 25 days. (See Summary box 67 in FIG. 5B).

As before, a legend 52 is provided, and an administrative box 57. Starbursts 65-69 on the future state administrative value stream map represent kaizen or continuous improvement actions that should occur to reach the future state process. At each starburst, the team is to prioritize the continuous improvement actions and assign champions and completion dates to each action to ensure that they are completed. This serves as part of a visual tool for an action list for implementation of the future state. Future state work flows 58 are shown, along with future state data and process boxes 53 and future state lean times 54 and 59. A list of objectives 99 is provided, along with a goal list 98 of current measurable targets. The receiving agent of the outputs is the end customer(s) 96. A summary box 95 shows total lead time and total process time for the future state administrative value stream.

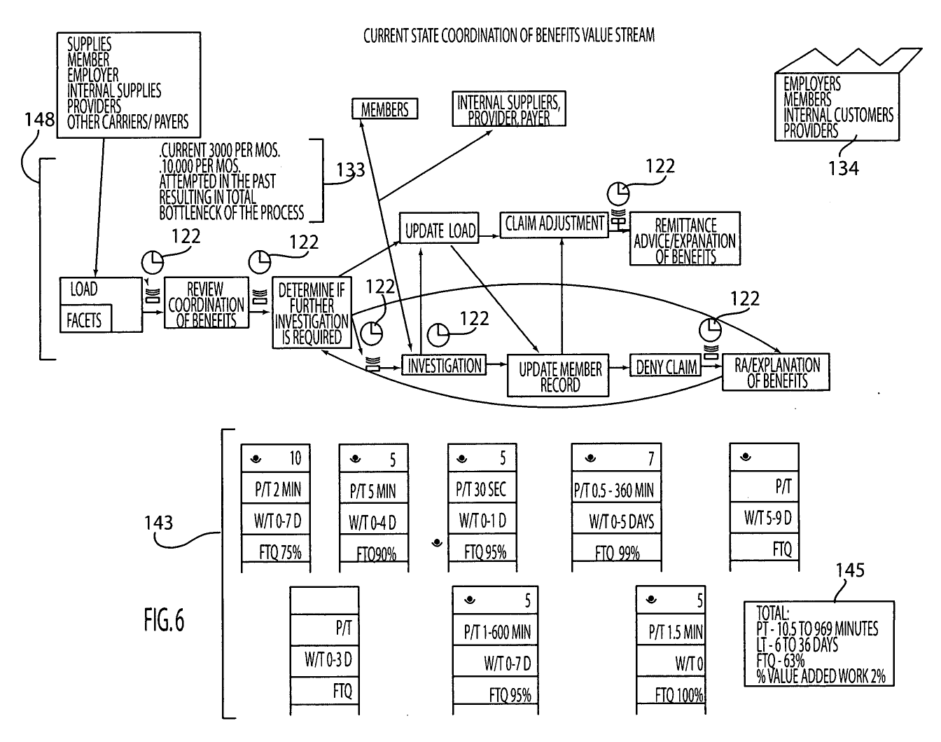

FIG. 6 provides an example of another current state administrative value stream map, an order-to-cash value stream entitled “Coordination of Benefits Value Stream”. As above, a series of data and process boxes 143 are shown, along with a labeled work flow 148. Inputs 133 are shown, required to initiate the administrative value stream. Receivers of outputs are shown at 134. Wait time is shown with a symbol 122. A summary box 145 is provided, indicating total lead time, total process time, and total percentage correct.

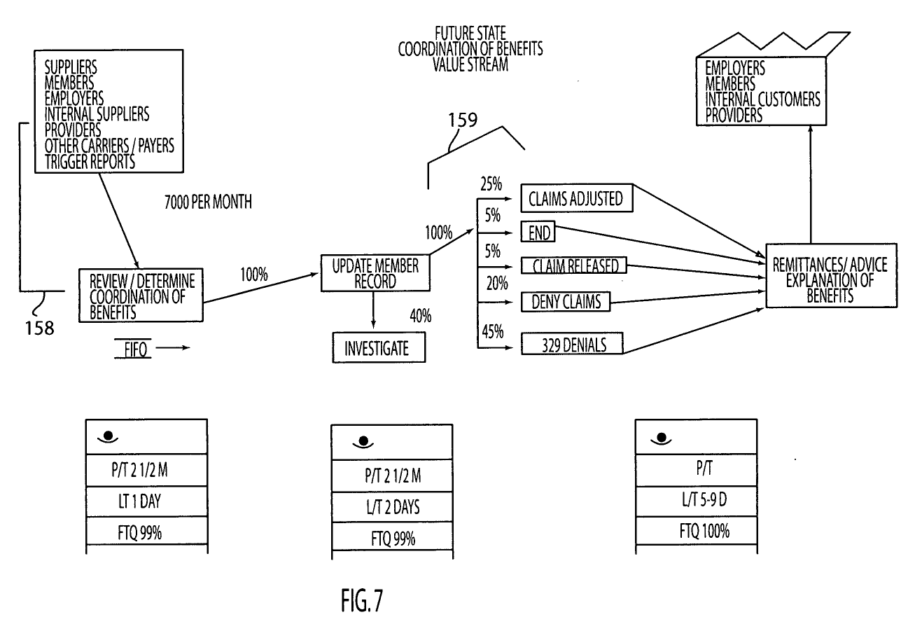

FIG. 7 is an example of a future state administrative value stream map made with lean concepts which corresponds to the value stream entitled “Coordination of Benefits Value Stream” shown in FIG. 6. Process and data boxes have been reduced, indicating a reduction in the number of steps. Here, a summary box is not provided (owing to the small number of steps). However, an advantage of the application of lean concepts is shown in the work flow 158, where a sorting mechanism 159 is introduced allowing simple tasks to be completed quickly, balancing out the flow of work (and consequently reducing the standard deviation between steps).

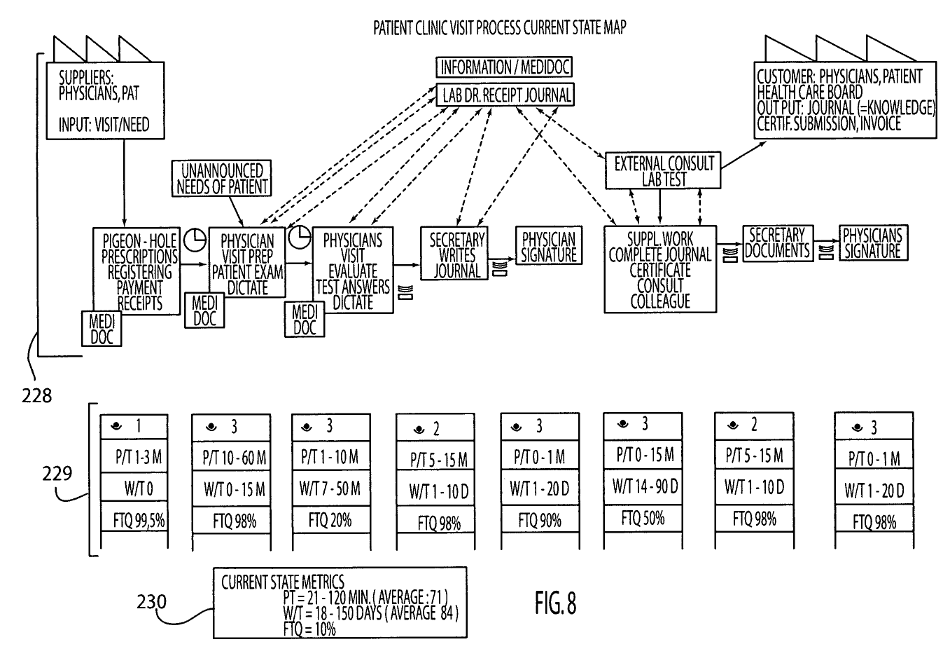

FIG. 8 provides an example of still another current state administrative value stream map, an order-to-cash value stream entitled “Patient Clinic Visit Process”. Information work flow 228, data and process boxes 229, and a summary box 230 are provided. The summary box 230 provides total lead time, total process time and total percentage correct.

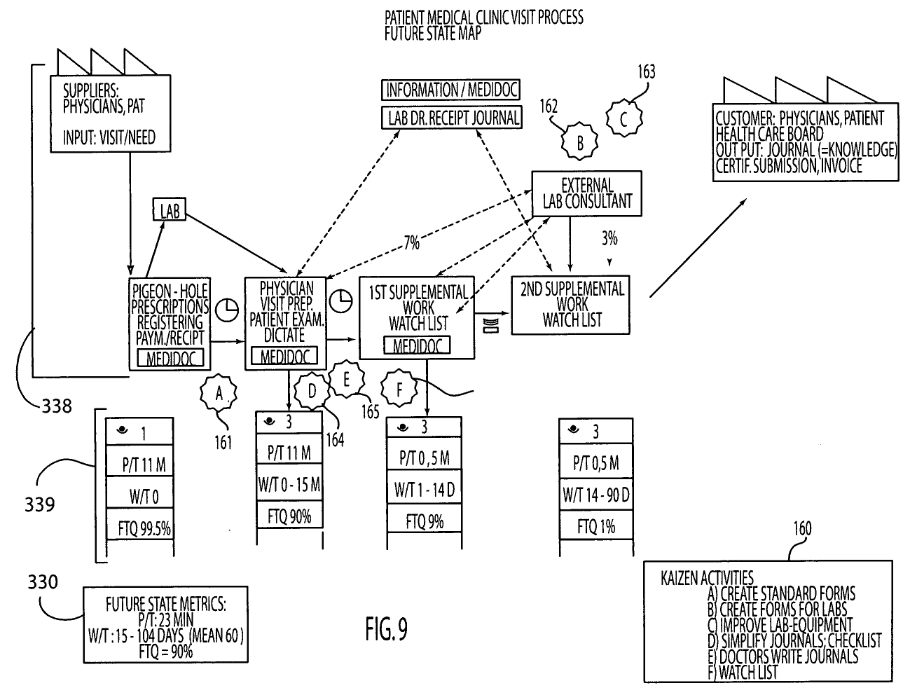

FIG. 9 provides an example of a future state administrative value stream map, based on application of lean concepts to the Patient Clinic Visit Process of FIG. 8. Kaizen activities 161-166, similar to the starbursts of FIG. 5B, are labeled in box 160. A work flow 338 is shown, along with data and process boxed 339, and a summary box 330 entitled “Future State Metrics”.

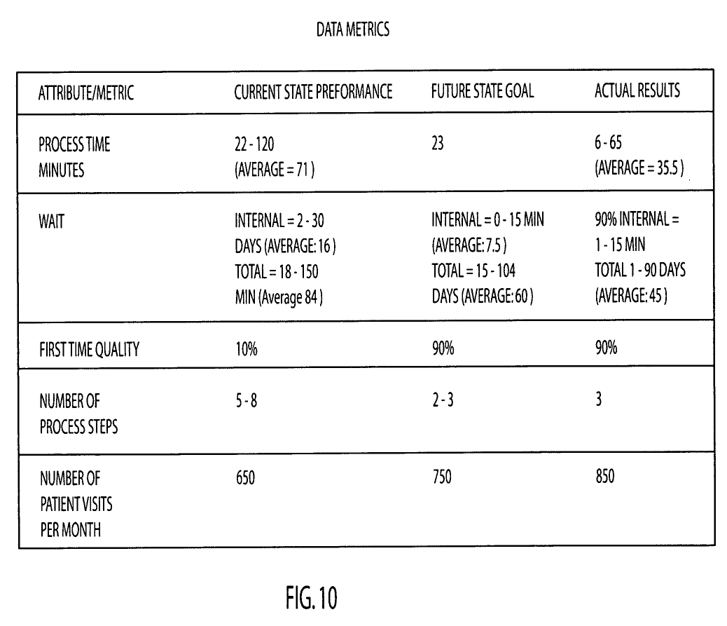

Box 330 is not a report of the actual measurements upon implementation of the future state administrative value stream. Rather, these metrics represent measurable goals. FIG. 10 is a comparison of the data metrics generated from the current state administrative value stream map of FIG. 8 and the future state administrative value stream map of FIG. 9, with the actual results after implementation. Thus, the actual results are monitored for comparison with what was expected to be achieved in the future state map.

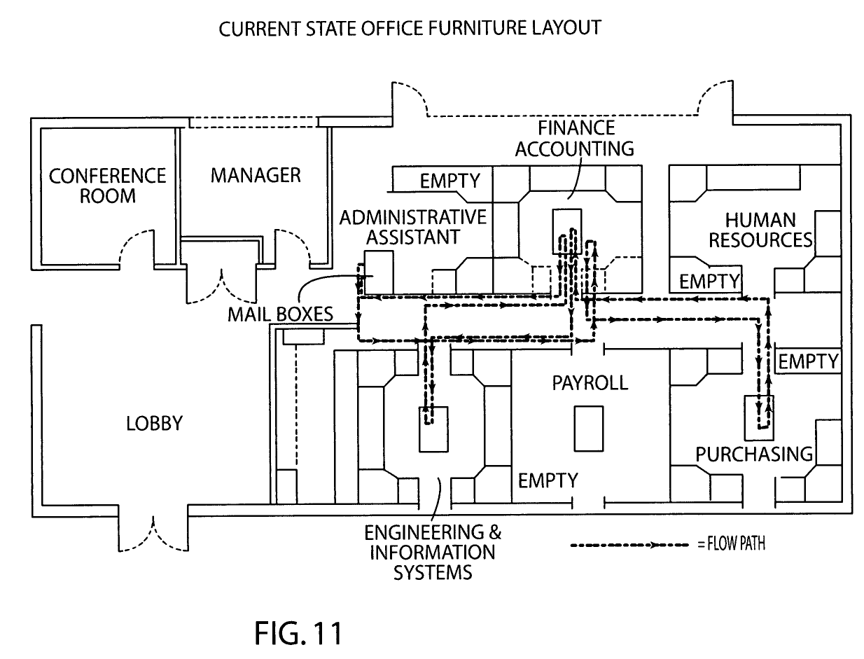

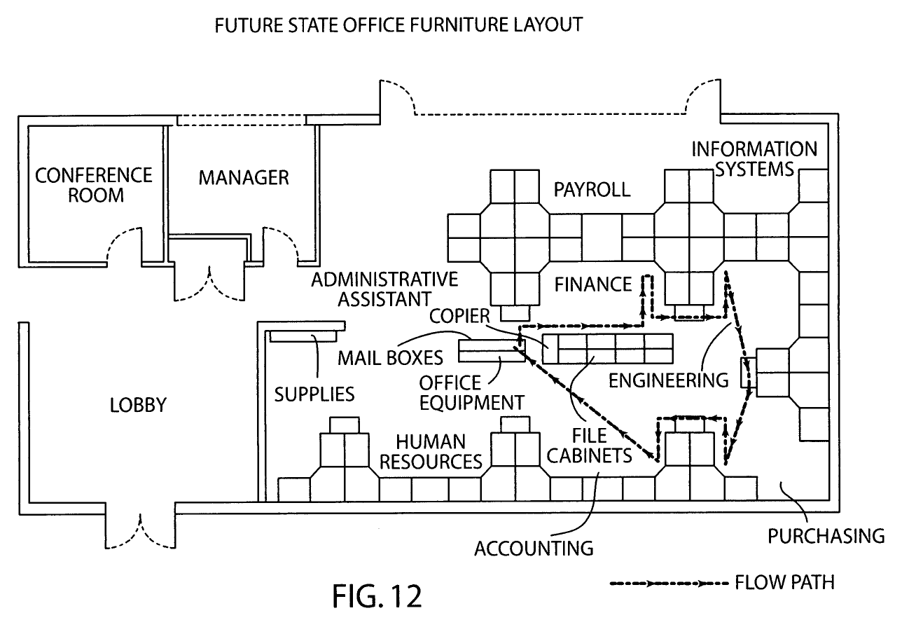

FIGS. 11-12 show how this process can be applied to improve an office furniture layout. In a competitive environment, companies are constantly trying to reduce cost and lead-time to deliver product and services, increasingly in the administrative processes. The waste within administrative processes; such as, review processes, correction of paperwork errors, incomplete information, and functional layout of employees, can be reduced here using the value stream approach. As a first step the business process (office layout) is identified, and the flow of work, manpower and information is mapped. A layout of the existing office furniture is disclosed in FIG. 11. This is not a current state administrative value stream map, but rather, is merely provided to show a ‘before’ state for the office furniture layout. The current state layout has separated cubicles and large cabinets that block visual communication. There is no balanced flow of materials: work that travels from one cubical to the next is placed in a basket or a mailbox and reviewed a few times each day. The layout creates a feeling of separation and individuality, versus a desired team mentality. Wasted motion is spent getting up from the desk and walking to see if the employee in need is available, there is no visual communication within the work environment.

The value stream approach is an advantage to potential customers of the business because improved office layout and furniture reduces cost and improves effectiveness of work flow (reduces inefficiency). The method disclosed herein is also an advantage to a furniture manufacturer because it has the opportunity to now supply more value added feature, beyond just office products. That is, the furniture manufacturer can provide both a product and a consulting service to help its customers become more competitive in their respective markets. A new office furniture layout is shown in FIG. 12, the result of applying lean concepts to a current state value stream map (not shown). The new office design would eliminate the functional islands present in almost all office workplace business steps. Its layout would mix all functions necessary to the value stream in a single physical flow arrangement.

As the value stream mapping team uncovers the waste within the system they streamline the process by developing a future state administrative value stream, which includes developing a future state office layout, the ‘after’ view shown in FIG. 12. As this new future state administrative value stream is developed the furniture designers are able to recommend lean office designs that will enhance the new layout, creating a lean office.

The value stream future state map directs the layout of the office furniture to enhance flow and take out waste or non-value added steps in the process. Use of functions, i.e., accounting, purchasing, etc. as shown in FIG. 12 is removed as the primary criteria used in the placement of people and desks and office equipment. Once the future state administrative value stream is defined through value stream mapping, the traditional office layouts of functional areas are broken up and the office furniture is laid out based on flow and processes. This would start to mix functions in the same work area. The flow of the service or material in the business process dictates the layout. Cross-functional training may also be used to further increase efficiency and reduce waste.

The future state layout is based off of a team concept, but far different than a traditional team grouping currently used in business today. In the traditional grouping used today, teams are usually part of a project team and are grouped together to enhance team communication as they go about their selected assignments. These assignments are often not at all related to any value stream analysis. In this proposed embodiment the physical office layout would be organized by flow of value as dictated by the future state administrative value stream map, work materials can flow from one worker to the next and can be handed directly to the next process, without additional movement. The open center section with small filing cabinets allows employees to easily see if others are available and creates a visual workplace. The community meeting area helps reduce lead time in that it allows employees to quickly meet and get questions answered versus, for example, placing the work in an “in-box” and waiting for a response. Lean concepts results in a layout that eliminates the barriers that create waste, functional layouts, cubical walls, and large tables and cabinets.

For a furniture manufacturer, the office design, layout and training is based around the administrative value streams (order-to-cash or concept-to-launch). A value stream enterprise approach is used to examine the various workstreams or administrative steps. The creation of a future state administrative value stream map for office equipment and position of workers eliminates waste and cost prior to deciding how much furniture a customer (or potential customer) needs. Lean office advisors of a furniture manufacturer can show the customer/potential customer what furniture and accessories are available to reduce the cost and lead time. This helps improve the competitive position the furniture manufacturer. Implementation of the future state allows the furniture manufacturer's customer to take out structural costs in their organization, and these costs amount to an ongoing savings year after year. Some of this cost savings would pay for a portion of the new furniture. Thus, the furniture manufacturer is not only providing their customer with office products, but at the same time helping their customers be more competitive.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A method for improving an administrative function of a business comprising, in combination, the steps of:
selecting an administrative value stream having a series of steps;
preparing a current state value stream map corresponding to the administrative value stream;
preparing a future state value stream map based on lean concepts to create a future state administrative value stream; and
implementing the future state administrative value stream.

2. The method of claim 1 wherein the administrative value stream comprises at least one of the groups of concept-to-launch value streams and order-to-cash value streams.

3. The method of claim 2 wherein the group of concept-to-launch value streams comprises at least one of:
a drafting release process;
a pricing process;
a procurement process;
an engineering proposal process;
a process for customer ordering and preparation of quotes for the customer;
a product development process; and
a control plan release process.

4. The method of claim 2 wherein the group of order-to-cash value streams comprises at least one of:
an order lead time process;
a customer return process;
a contested invoice process;
a month end closing process;
a new hire application process;
a drafting revision process;
a product enhancement process;
a clinic visit process;
a clinic discharge process; and
a coordination of benefits process.

5. The method of claim 1 wherein the current state value stream map contains at least:
a list of steps of an administrative value stream;
a lead time of each step;
a process time for each step;
a total percentage correct for the administrative value stream; and
an information flow between steps.

6. The method of claim 5 wherein the current state value stream map further comprises at least one of:
a value added time for each step;
a number of workers required for each step;
a number of times rework was done or revisions required;
an identification of the kind of information technology used;
a batch size; and
a range and average for the lead time for at least one of the steps of the administrative value stream.

7. The method of claim 1 wherein the lean concepts comprise at least one of:
organizing work stations in the order of each step of an administrative value stream;
presenting visual status of the administrative value stream to workers working on that value stream;
balancing workflow between steps of the administrative value stream;
reducing batch size;
cross-training workers;
placing workers together who work together on the administrative value stream;
setting a pace of the administrative value stream based on available time divided by customer demand; and
standardizing work done by different workers working on the same administrative value stream.

8. The method of claim 1 wherein a first administrative value stream which occurs before a second administrative value stream is upstream of the first administrative value stream, and a third administrative value stream which occurs after a second administrative value stream is downstream of the second administrative value stream, and further comprising the step of:
selecting a group of workers to select the administrative value stream, prepare a current state value stream map, and prepare a future state value stream map based on lean concepts;
wherein the group of workers comprises workers experienced in the administrative value stream, workers experienced in the upstream administrative value stream, and workers experienced in the downstream administrative value stream.

9. The method of claim 1 further comprising the step of
developing an action list to implement the future state value stream.

10. The method of claim 1, after the step of implementing the future state value stream, further comprising the step of
monitoring implementation of the future state administrative value stream.

11. The method of claim 1 further comprising the step of:
checking the future state administrative value stream for potentially patentable subject matter.

12. The method of claim 1 further comprising the step of:
developing a layout of office equipment and position of workers using the future state value stream map.

13. The method of claim 12 wherein the layout of office equipment and position of workers is based on work flow.

14. The method of claim 12 wherein the step of developing a layout of office equipment and position of workers is performed by a manufacturer of office furniture on behalf of one of its customers and its potential customers.

15. The method of claim 1 further comprising the step of:
using a workshop to prepare the current state value stream map and to identify the future state administrative value stream.

16. The method of claim 1 wherein the current state value stream map of the administrative value stream shows a series of steps, wherein each step has a lead time, and the series of steps has both a mean of lead times and a standard deviation of lead times; and the future state value stream map has a standard deviation of lead times which is less than the standard deviation of lead times in the current state value stream map.

17. The method of claim 1 wherein the current state value stream map of the administrative value stream shows a series of steps, wherein each step has a lead time, and the series of steps has a total lead time; and
the future state value stream map has a total lead time which is less than the total lead time in the current state value stream map.

18. The method of claim 1 wherein the current state value stream map of the administrative value stream shows a series of steps, wherein each step has a process time, and the series of steps has a total process time; and
the future state value stream map has a total process time which is less than the total process time in the current state value stream map.

19. The method of claim 1 wherein the current state value stream map of the administrative value stream has a total percentage correct and the future state value stream map has a total percentage correct which is greater than the total percentage correct in the current state value stream map.
